(19) United States
(12) Patent Application Publication
(10) Pub. No.: US 2006/0145472 A1
(43) Pub. Date: Jul. 6, 2006

(54) Folded self-adhesive label

(76) Inventor: Hilfling Dan Petersen, Viby S (DK)

Correspondence Address: WILLIAM J. SAPONE;COLEMAN SUDOL SAPONE P.C., 714 COLORADO AVENUE, BRIDGE PORT, CT, 06605, US

(21) Appl. No.: 10/547,411

(22) PCT Filed: Mar. 11, 2004
(86) PCT No.: PCT/DK04/00155

§ 371 Date: Aug. 30, 2005

(30) Foreign Application Priority Data
Mar. 11, 2003 (DK) PA 2003 00359

(51) Int. Cl. B42D 15/00

(52) U.S. Cl. 283/106

(57) ABSTRACT

A self-adhesive folding label (2) according to the invention is made by punching and application to the upper side of the label web and configured such that one or more folding parts (5) may be folded inwards below a bottom part (6) and a top part (4). These folding parts (5) have a smaller extent that the bottom and top parts so that no adhesion will occur. Hereby, opening and folding of the label may take place in a simple manner without any risk of tearing of the individual parts.

### STATE OF THE ART

The invention relates to a label with print on the front and adhesive on the back which may be adhered to a package surface or the like after folding.

Labels of this type are preferably used on packages where information, commodity facts, etc. are to be provided on limited space. When the label may be unfolded, space may be made available for printing because of the relatively large face of the unfolded label.

Further, labels of this type may serve as a form of covering communication for use on parcels and the like, as the desired data, information, etc. may be applied to the unfolded parts of the label, which may then be folded together and be adhered to the parcel.

U.S. Pat. No. 5,509,694 discloses an example of a multi-fold label which may be provided with various items of information prior to folding and adhesion to the parcel. Portions of the label may be removed from the base portion by means of various weakened lines, and the base portion may moreover be separated additionally.

The label has been developed for this special purpose and is not suitable for use as a label on e.g. convenience goods, party because it is expensive to manufacture owing to its complex configuration, partly because it just has two faces for printing or marking.

### OBJECT OF THE INVENTION

The object of the invention is to provide a label which is simple and thereby relatively inexpensive to manufacture, which provides more sections on which printing may be performed, which is simple to apply with ordinary application equipment, and which is easy to open for the user.

This is achieved according to the invention in that the label is provided with two bending lines extending mutually in parallel at a distance to form a folding part which extends between partly a bottom part which may be adhered to the package surface and partly a top part which, bent in the bending line, is capable of folding the part inwards over the bottom part adhering to the surface, with the top part positioned over the folding part adhering to the upper side of the bottom part.

In this surprisingly simple manner, the manufacture may take place on the basis of generally known self-adhesive label material, be it fabric, paper or plastics sheet, to which a non-glue-adhering carrier web, such as a silicone-coated web, has been applied.

Punching, perforation and subsequent printing may hereby be carried out in a continuous operation, since the working takes place on the unfolded label on the carrier web.

After manufacture, the label may be lifted from the carrier web and be folded together and, in this state, be placed on the package preferably by means of an applicator machine.

The positioning of bending lines and tearing webs ensures that opening as well as closing of the label is uncomplicated for the consumer.

When, as defined in claim 2, the folding part is reduced, it is ensured that it does not adhere to either the top part or the bottom part, and thereby remains contiguous with these.

When, as stated in claim 3, either the bottom part or the top part is provided with perforations extending externally of the folding part, the label may easily be opened and closed without the folding part being ruptured.

When, as stated in claim 4, the top part is provided with additional folding parts positioned oppositely, the number of “leaves” may be increased, thereby creating more space for printing.

When, as stated in claim 5, these folding parts are reduced, they will not be able to adhere to each other, but serve as leaves.

When, as stated in claims 6 and 7, the top and bottom parts are dimensioned such that, adhered together, they constitute a protruding part of the label, the label may easily be lifted by the thus-produced flap such that the label is easy to open and unfold.

### THE DRAWING

Embodiments of folded labels according to the invention will be described more fully below with reference to the drawing, in which

FIG. 1 shows a plane package with a folded label,

FIG. 2 shows a curved package with a folded label,

FIG. 3 shows a label prior to folding,

FIG. 4 shows the label of FIG. 3 during folding,

FIG. 5 shows a second embodiment of a label prior to folding,

FIG. 6 shows the label of FIG. 5 during folding,

FIG. 7 shows a further embodiment of a label prior to folding,

FIG. 8a shows the label of FIG. 7 during a first folding, and

FIG. 8b shows the label of FIG. 7 during a second folding.

### DESCRIPTION OF THE EMBODIMENTS

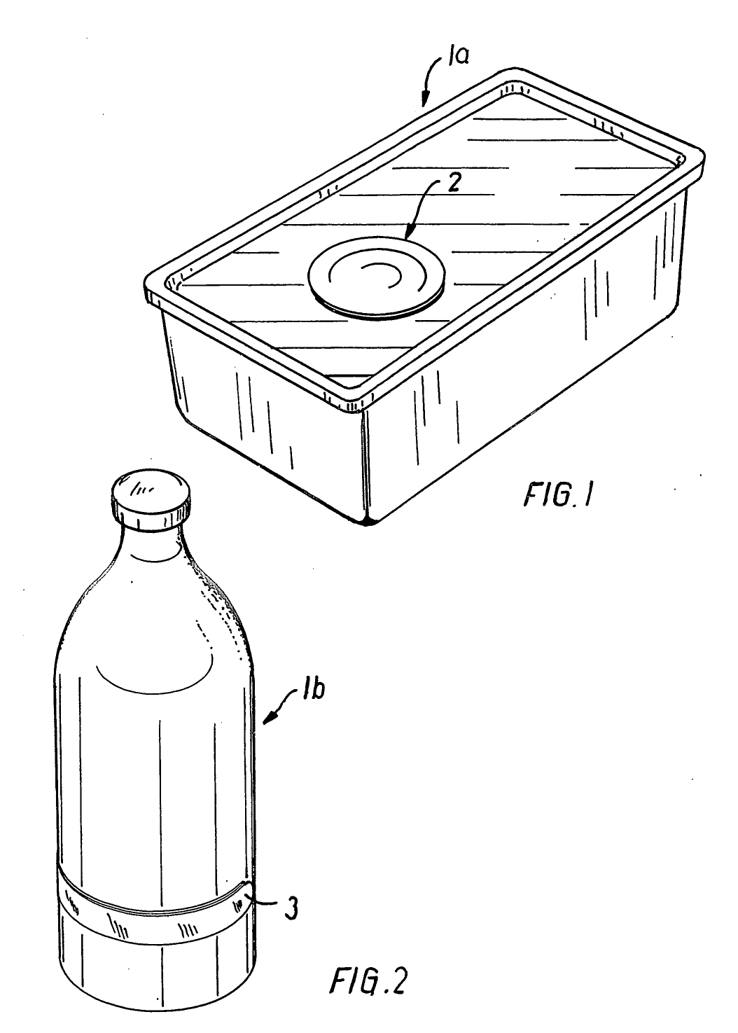

The invention will be explained below in connection with the description of three embodiments of folded self-adhesive labels, as shown e.g. in FIG. 1 where a round label 2 is adhered to a plane lid on a package 1a, and in FIG. 2 where an elongated label 3 is adhered to a curved package surface 1b.

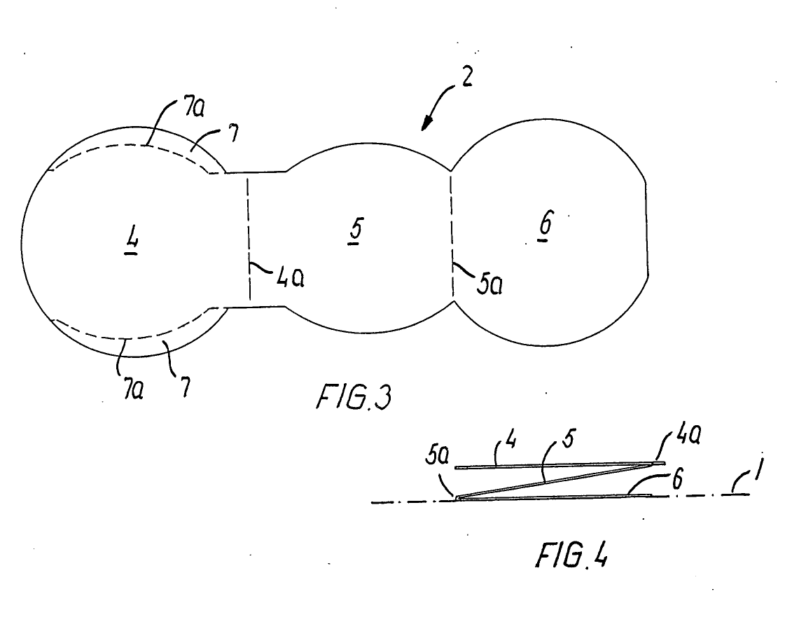

The first embodiment is shown in FIG. 3, which shows the configuration of the basic label as it appears after the punching.

It comprises three parts, viz. a bottom part 6, a folding part 5 and a top part 4. It is characteristic of these parts that they have different shapes, and that they are provided with two bending lines 4a and 5a which separate the parts, and moreover with perforations 7a in the top part 4.

When the extent of the bottom part 6 has been determined, the top part 4 is dimensioned correspondingly, as these two parts 4 and 6 are to be disposed over each other when the package has been folded.

The folding part 5 has a smaller extent than the top and bottom parts such that when the folding part 5 has been folded in and the label assembled, as indicated in FIG. 4, which shows the label during folding, the folding part 5 will extend between the bottom part 6 and the top part 4 within the area defined by the perforations 7a.

The purpose of these perforations is to form two rim portions 7 which are to remain adhered to the bottom part 6 when the label is opened, where the perforations 7a will constitute tearing webs.

It appears from FIG. 4 that the folding edge 4a will protrude a distance out-side the bottom part 6, and since the top part 4 and the folding part 5 will adhere to each other in this rim portion, it will constitute a flap.

Since this flap consists of two adhered label layers and extends above the package by the thickness of the bottom part 6, the flap may easily be lifted clear, following which a pull will tear the perforations 7a. The label may then be unfolded.

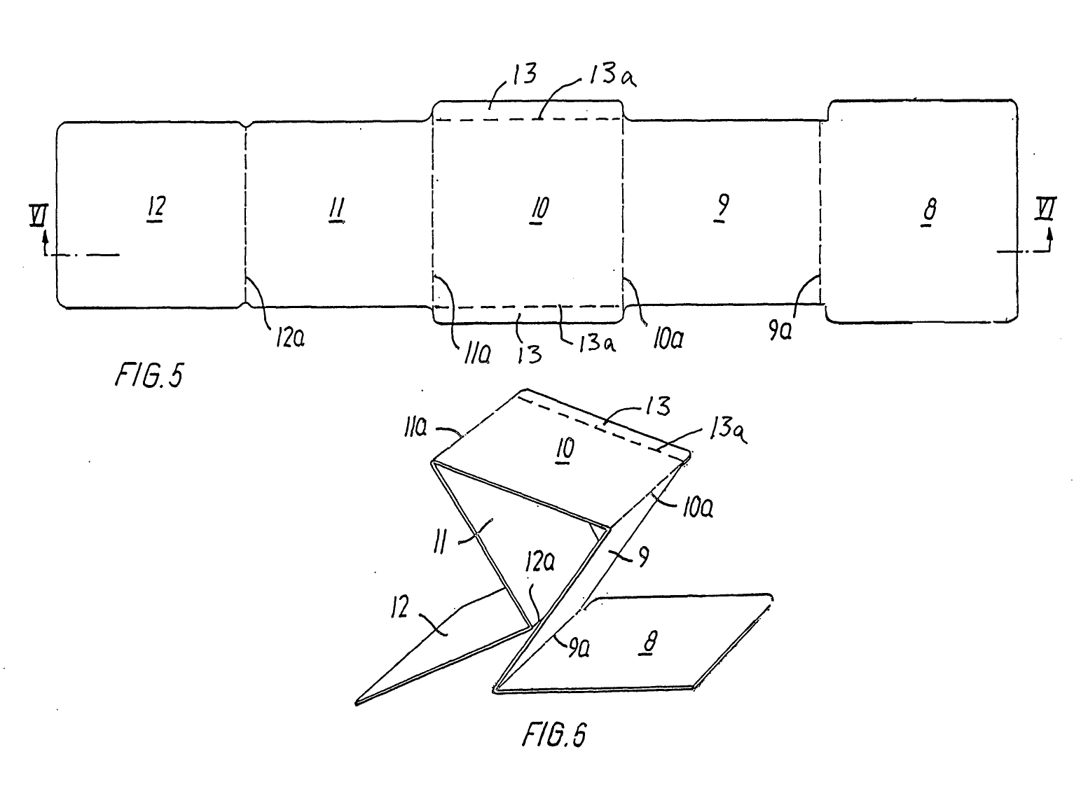

The second embodiment is shown in FIGS. 5 and 6.

The starting label is shown in FIG. 5 and differs from the first embodiment in that further folding parts 11, 12 have been added to the left in the figure from the top part 6, so that this example includes a total of five faces for printing/imaging.

Tearing of the part serving as a seal of the package is at a perforation 13a in the top part 10 in this case.

FIG. 6 indicates the folding principle, comprising two folding operations, viz. partly the folding of the folding parts 11, 12 inwards below the top part 10, following which the top part 10 with the folding part 9 may be folded and the protruding portions of the top part may be adhered to the protruding portions 13 of the bottom part.

Since, in this example too, the folding edge 10a protrudes slightly forwardly of the bottom part 8, it will form a flap of two adhered package layers which protrudes above the package, and which may be used for tearing and unfolding the label.

In this example too, the folding parts 9, 11, 12 are smaller than the top and bottom parts 8, 10 so that the folding parts cannot adhere together, but may freely be unfolded after the opening of the label.

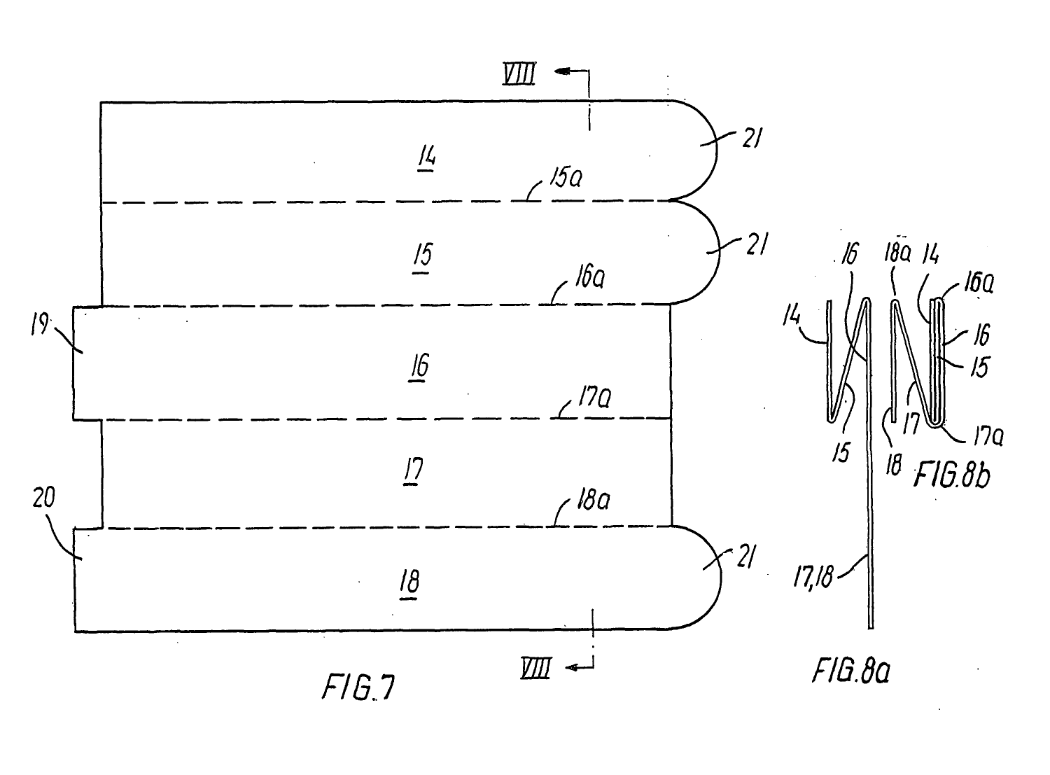

The third embodiment is shown in FIGS. 7 and 8. As indicated in FIG. 2, this embodiment is particularly suitable for adhesion to curved surfaces, such as a can or a bottle 1b.

The starting point is the basic workpiece shown in FIG. 7 which comprises elongated parts.

The parts are formed by a bottom part 16 which is additionally connected on both sides with a folding part 17 and a top part 18 disposed at the bottom of FIG. 7 and two folding parts 15 and 18 disposed at the top of FIG. 2.

All the bending lines, which are also tearing lines, extend in parallel and at the same mutual distance.

It is observed that all the folding parts 14, 15, 17 are slightly shorter than the top and bottom parts 18 and 16, which terminate in protruding portions 19 and 20, whose function will be described later.

The opposite end of the label is provided with protruding annular parts 21 on the top part 18 as well as on the two uppermost folding parts 14 and 15.

It is indicated in FIG. 8a how the first folding takes place by folding the uppermost folding parts 14, 15 inwards over the bottom part 16.

Then, as indicated in FIG. 8b, the lowermost folding part 17 is folded inwards so that the top part 18 closes the package in that the rounded portions 21 and the oppositely positioned, protruding parts 19 and 20 are adhered together.

This results in a closed, folded, elongated label which is suitable for use on curved webs, as it may be bent and adhered in the entire extent of the bottom part 16.

When the label has been adhered to the package, the rounded parts 21 on the top part will be adhered to the joined ends on the folding part 14 which has been adhered to the folding part 15. At a pull at the end parts 21, the free connected layers 14, 15, 17, 18 will be separated by tearing of the perforations and remain hinged to the package by adhesion of the ends 19, 20.

This will result in the formation of five faces, viz., from below, the bottom part 16 and a part, hinged thereto, comprising the top part 18 adhered to the folding part and in extension thereof the folding parts 14 and 15 adhered together.

The extension is kept together by the adhered rounded parts 21.

It is within the scope of the invention to insert loose portions between the top part, the folded parts and the bottom part, as the package will serve as a kind of pocket for any loose parts, such as lottery tickets, pictures, etc.

1. A label with print on the front and adhesive on the back which may be adhered to a package surface or the like after folding, characterized in that the label (2, 3) is provided with two bending lines (4a, 5a, 9a, 10a and 17a, 18a) extending mutually in parallel at a distance to form a folding part (5, 9, 17), which extends between partly a bottom part (6, 8,16) which may be adhered to the package surface and partly a top part (4, 10, 18) which, bent in the bending line (4a, 5a, 9a, 10a and 17a, 18a), is capable of folding the part (5, 9,17) inwards over the bottom part (6, 8, 16) adhering to the surface, with the top part (4, 10, 18) positioned over the folding part (5, 9, 17) adhering to the upper side of the bottom part (6,8,16).

2. A label according to claim 1, characterized in that the folding part (5, 9, 17) has a smaller extent than the adjacent label parts (6, 8, 16 and 4, 10, 18) to prevent adhesion to these.

3. A label according to claim 2, characterized in that the adhesive label part (4, 8, 16) is provided with perforations (7a, 13a, 17a, 18a) corresponding to the extent of the folding part (5, 9, 17).

4. A label according to claims 1-3, characterized in that a further bending line (11a, 16a) and a label part (11, 15) and optionally further bending lines (12a, 15a) and label parts (12, 14) extend along the extent of the top part (10, 16), said parts (11, 12 and 14, 15) being foldable inwards below the top part (10, 18) before this is folded and adhered to the bottom part (8,16).

5. A label according to claim 4, characterized in that the further label parts (11, 12) have an extent essentially corresponding to that of the folding part (9) to prevent adhesion to the adjacent parts (8,10).

6. A label according to claims 1-3, characterized in that the bending edge (4a, 10a) protrudes a distance from the adhesive bottom part (6, 8) to form a lifting flap.

7. A label according to claim 4, characterized in that projections (21) are provided on the parts (14, 15, 18) which are to be separated in the perforations (15a, 16a, 18a) by a pull in the flap formed by the projections (21) adhered together (FIG. 7).
